(19) United States
(12) Patent Application Publication
(10) Pub. No.: US 2026/0323440 A1
(43) Pub. Date: Oct. 15, 2026

(54) METHOD AND APPARATUS FOR HANDLING SLICE BASED CELL RESELECTION PRIORITIES

(71) Applicant: SAMSUNG ELECTRONICS CO., LTD., Suwon-si, Gyeonggi-do (KR)

(72) Inventors: Aby Kanneath ABRAHAM, Bangalore (IN); Sangyeob JUNG, Suwon-si (KR)

(21) Appl. No.: 19/102,774

(22) PCT Filed: Aug. 9, 2023
(86) PCT No.: PCT/KR2023/011757

§ 371 Date: Feb. 10, 2025

(30) Foreign Application Priority Data
Aug. 9, 2022 (IN) 202241045481
Jun. 27, 2023 (IN) 202241045481

(51) Int. Cl. H04W 36/08; H04W 36/00

(52) U.S. Cl. CPC H04W 36/08; H04W 36/0072

(57) ABSTRACT

The disclosure relates to a 5G or 6G communication system for supporting a higher data transmission rate. Embodiments herein provide a method for handling slice based cell reselection priorities by a UE (100). The method includes receiving a RRC message including a slice information for a NSAG at a frequency and without any priority information. Further, the method includes receiving a RRC message including a slice information for a NSAG including priority information for a NSAG at another frequency. Further, the method includes determining whether the RRC message includes the slice information with the priority information or the slice information without the priority information. Further, the method includes determining a lowest priority value for the frequency when the RRC message includes the slice information without the priority information. The lowest priority value is lower than any of the priority information configured for the frequency. Further, the method includes performing cell reselection based on the lowest priority value for the frequency and the slice information.

### TECHNICAL FIELD

The present disclosure relates to a wireless communication, and more specifically, the present disclosure relates to methods and a User Equipment (UE) for handling slice based cell reselection priorities.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for handling slice based cell reselection priorities.

The principal object of the embodiments herein is to provide methods and a UE for handling slice based cell reselection priorities.

Another object of the embodiments herein is to provide that upon receiving slice information (i.e., sliceInfo) for two frequencies F1 and F2, where the sliceInfo for F1 doesn't contain NSAG cell reselection priority and sliceInfo for F2 contain NSAG cell reselection priority set as zero, the UE considers both F1 and F2 are equal priorities.

Another object of the embodiments herein is to provide that upon receiving RRC Release with slice information without any priority, the UE ignores any priorities received in a SIB2 and a SIB4.

Another object of the embodiments herein is to provide that upon receiving the RRC Release with slice information, the UE considers only the NSAG-Frequency pair present in the FreqPriorityListDedicatedSlicing (i.e. dedicated signalling) irrespective of the presence of NSAG-Frequency pair in FreqPrioritySlicing (i.e. system information).

### Solution to Problem

Accordingly, the embodiments herein provide a method for handling slice based cell reselection priorities. The method may include receiving, by a UE, a RRC message including a slice information for a Network Slice AS Groups (NSAG) at a frequency and without any priority information. Further, the method includes receiving, by the UE, a RRC message including a slice information for a NSAG including priority information for a NSAG at another frequency. Further, the method includes determining, by the UE, whether the RRC message includes the slice information with the priority information or the slice information without the priority information. Further, the method includes determining, by the UE, a lowest priority value for the frequency when the RRC message includes the slice information without the priority information, where the lowest priority value is lower than any of the priority information configured for the frequency. Further, the method includes performing, by the UE, cell reselection based on the lowest priority value for the frequency and the slice information.

In an embodiment, the method may include configuring, by the UE, to ignore the priority information received in at least one system information block (SIB) and performing slice based cell reselection using only the NSAG-Frequency pairs without priority information received in a RRC Release when the RRCRelease includes the slice information including NSAG-Frequency pairs without including the priority information for all the NSAG-Frequency pairs and the RRC Release does not comprises NR frequencies or E-UTRA frequencies associated to non-slice specific priorities.

In an embodiment, the method may include performing the slice based cell reselection by considering only the NSAG-frequency pairs indicated in the FreqPriorityListDedicatedSlicing.

In an embodiment, the priority information includes at least one of a nsag-CellReselectionPriority, a nsag-CellReselectionSubPriority, CellReselectionPriority and CellReselectionSubPriority.

In an embodiment, the RRC message may be an RRCRelease or the SIB.

In an embodiment, the SIB may be one of a SIB2 and a SIB4.

In an embodiment, the method may include receiving, by the UE, slice information for a first frequency (F1) and a second frequency (F2). The slice information for the F1 doesn't include the priority information and the slice information for the F2 includes the priority information set as zero. Further, the method includes determining, by the UE, the F2 is higher priority than the F1 when the F1 doesn't include the priority information and the F2 includes the priority information set as zero.

Accordingly, the embodiments herein provide a UE for handling slice based cell reselection priorities. The UE may include a slice based cell reselection controller communicatively coupled to a memory and a processor. The slice based cell reselection controller is configured to receive a RRC message including a slice information for a NSAG at a frequency and without any priority information. Further, the slice based cell reselection controller is configured to receive a RRC message including a slice information for a NSAG including priority information for a NSAG at another frequency. Further, the slice based cell reselection controller is configured to determine whether the RRC message includes the slice information with the priority information or the slice information without the priority information. Further, the slice based cell reselection controller is configured to determine a lowest priority value for the frequency when the RRC message includes the slice information without the priority information. The lowest priority value is lower than any of the priority information configured for the frequency. Further, the slice based cell reselection controller is configured to perform cell reselection based on the lowest priority value for the frequency and the slice information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and apparatus for handling slice based cell reselection priorities.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling slice based cell reselection priorities, according to the embodiments as disclosed herein;

FIG. 2A shows various hardware components of a UE, according to the embodiments as disclosed herein;

FIG. 2B shows various hardware components of a network apparatus, according to the embodiments as disclosed herein;

FIG. 3 is a flow chart illustrating a method for handling slice based cell reselection priorities, according to the embodiments as disclosed herein;

FIG. 4 is a flow chart illustrating a method for handling of RRC Release with slice Information without any priority, according to the embodiments as disclosed herein;

FIG. 5 is a flow chart illustrating a method for handling slice based prioritisation b/w NSAG cell reselection priority absent and NSAG cell reselection priority is zero, according to the embodiments as disclosed herein; and

FIG. 6 is a flow chart illustrating a method for handling slice based cell reselection using derived priorities, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following specification particularly describes and ascertains the nature of this invention and the manner in which it is to be performed:

A most prominent feature of fifth generation (5G) networks lies in adopting network slicing for radio access networks (RANs) and core networks (CNs). This is intended for bundling up network resources and network functions into a single independent network slice depending on individual services, allowing for application of network system function and resource isolation, customization, independent management and orchestration to mobile communication network architectures. The use of such network slicing enables offering 5G services in an independent and flexible way by selecting and combining 5G system network functions according to services, users, business models, or such references.

From technical specification (TS) 38.300 Release 16, a network slice always consists of a RAN part and a CN part. The support of network slicing relies on the principle that traffic for different slices is handled by different Protocol Data Unit (PDU) sessions. The wireless network can release the different network slices by scheduling and also by providing different layer 1/layer 2 (L1/L2) configurations.

The network slicing is a concept to allow differentiated treatment depending on each customer requirements. With slicing, it is possible for Mobile Network Operators (MNO) to consider customers as belonging to different tenant types with each having different service requirements that govern in terms of what slice types each tenant is eligible to use based on Service Level Agreement (SLA) and subscriptions.

Some slices may be available only in part of the network. The NG-RAN supported Single-Network Slice Selection Assistance Information (S-NSSAI) is configured by an Operations, Administration and Maintenance (OAM) entity. Awareness in the NG-RAN of the slices supported in the cells of the neighbours may be beneficial for inter-frequency mobility in a connected mode. It is assumed that the slice availability does not change within a UE's registration area. The NG-RAN and the 5GC are responsible to handle a service request for a slice that may or may not be available in a given area. The admission or rejection of access to the slice may depend by factors such as support for the slice, availability of resources, support of the requested service by the NG-RAN. In case, a UE is associated with multiple slices simultaneously, only one signalling connection is maintained and for intra-frequency cell reselection, the UE always tries to camp on a best cell.

When some of the slices are supported only in some frequencies, till a New Radio (NR) Release 16, NR networks used, dedicated priorities to control the frequency on which the UE camps. In NR release 17, slice specific prioritization is introduced. A serving cell can broadcast slice information including the slice support in serving as well as neighboring frequencies, slice specific priorities for serving as well as neighboring frequencies, details on the slice availability in the neighboring cells etc. There may be also some frequencies which may not be associated with any slices. The UE considers the slice priorities of the slices that the UE needs/supports along with the frequency priorities for the slices during cell reselection.

Cell reselection: According to 3rd Generation Partnership Project (3GPP) specification TS 38.300, the cell reselection is a process that identifies the cell that the UE should camp on when the UE is in a non-connected state (i.e. RRC_IDLE and RRC_INACTIVE). It is based on a cell reselection criteria. An inter-frequency reselection is based on absolute priorities where the UE tries to camp on the highest priority frequency available. The UE involves measurements of the serving and neighbour cells and the cell reselection can be speed dependent and in multi-beam operations. A cell quality is derived amongst the beams corresponding to the same cell. The UE may receive cell reselection priorities through the dedicated signalling or the broadcast signalling. In the legacy cell reselection (i.e., cell reselection not considering slices), if the network apparatus does not provide cell reselection priority for a certain frequency to the UE, the UE does not consider that frequency for cell reselection. In other words, the absence of cell reselection priority controls whether the UE needs to perform cell reselection or not.

From TS 38.304 v17.1.0, absolute priorities of different NR frequencies or inter-RAT frequencies may be provided to the UE in a system information, in a RRCRelease message, or by inheriting from another RAT at inter-RAT cell (re) selection. In the case of system information, an NR frequency or inter-RAT frequency may be listed without providing a priority (i.e. the field cellReselectionPriority is absent for that frequency). If any fields with cellReselectionPriority or nsag-CellReselectionPriority are provided in dedicated signalling, the UE ignores any fields with cellReselectionPriority and nsag-CellReselectionPriority provided in the system information. When the UE is in a camped normally state, if the UE supports slice-based cell reselection and has received NSAG(s) and their priorities from a Non-access stratum (NAS) layer, the UE derives re-selection priorities according to slice aware cell reselection rules.

Slice aware cell reselection based on network Slice AS Groups (NSAG)/Slice Groups: The NSAG or Slice Group is a group which is associated to one or more slices. If the UE has indicated that the UE supports the NSAG, an Access & Mobility Management Function (AMF) may configure the UE with NSAG Information for one or more the S-NSSAIs in a configured NSSAI, by including the NSAG Information in a Registration Accept message or a UE Configuration Command message. The AMF indicates in the NSAG Information in which tracking area (TA) a specific NSAG association to S-NSSAI(s) is valid if the AMF provides in the UE configuration a NSAG value which is used in different TAs with a different association with NSSAIs. The configuration the AMF provides includes at least the NSAGs for the UE for the Tracking Area (TA) s of a Registration Area.

A NR UE RRC may receive NSAG and a priority associated with the NSAG from a NAS layer. The NR UE RRC also may receive one of a lists-FreqPriorityListSlicing or FreqPriorityListDedicatedSlicing including a frequency provided either explicitly or as implicitly through an index to an entry in system information, a slice information list which contain as list of slice information (sliceInfo or sliceInfoDedicated) including an identifier for a NSAG and optionally the nsag-CellReselectionPriority or nsag-CellReselectionSubPriority applicable for the NSAG for the frequency, and in the case of sliceInfoDedicated, a cell list (sliceCellListNR) which includes the list of PCIs which may be either an allowed list (sliceAllowedCellListNR) or excluded list (sliceExcludedCellListNR). There can be frequencies without priorities in the sliceInfo or sliceInfoDedicated and such NSAGs may be considered as lowest frequency priority for the NSAG. Below extracts from NR RRC 17.1.0 illustrates the structures as shown below.

-- ASN1START
-- TAG-FREQPRIORITYLISTDEDICATEDSLICING-START

| | |
|---|---|
| FreqPriorityListDedicatedSlicing-r17 ::= | SEQUENCE (SIZE (1.. maxFreq)) OF |

FreqPriorityDedicatedSlicing-r17

| | |
|---|---|
| FreqPriorityDedicatedSlicing-r17 ::= | SEQUENCE { |
| dl-ExplicitCarrierFreq-r17 | ARFCN-ValueNR, |

| | |
|---|---|
| sliceInfoListDedicated-r17 | SliceInfoListDedicated-r17 |

OPTIONAL -- Need R
}

| | |
|---|---|
| SliceInfoListDedicated-r17 ::= | SEQUENCE (SIZE (1..maxSliceInfo-r17)) OF |

SliceInfoDedicated-r17

| | |
|---|---|
| SliceInfoDedicated-r17 ::= | SEQUENCE { |
| nsag-IdentityInfo-r17 | NSAG-IdentityInfo-r17, |

| | |
|---|---|
| nsag-CellReselectionPriority-r17 | CellReselectionPriority |

OPTIONAL, -- Need R

| | |
|---|---|
| nsag-CellReselectionSubPriority-r17 | CellReselectionSubPriority |

```
OPTIONAL -- Need R
      }
      -- TAG-FREQPRIORITYLISTDEDICATEDSLICING-STOP
  -- ASN1STOP.
  -- ASN1START
  -- TAG-FREQPRIORITYLISTSLICING-START
  FreqPriorityListSlicing-r17 ::= SEQUENCE (SIZE (1..maxFreqPlus1)) OF
    FreqPrioritySlicing-r17
```

| FreqPrioritySlicing-r17 ::= | SEQUENCE { | |
|---|---|---|
| dl-ImplicitCarrierFreq-r17 | INTEGER (0..maxFreq), | |
| sliceInfoList-r17 | SliceInfoList-r17 | OPTIONAL |

```
    -- Need R
  }
```

| | |
|---|---|
| SliceInfoList-r17 ::= | SEQUENCE (SIZE (1..maxSliceInfo-r17)) OF SliceInfo-r17 |
| SliceInfo-r17 ::= | SEQUENCE { |
| nsag-IdentityInfo-r17 | NSAG-IdentityInfo-r17, |
| nsag-CellReselectionPriority-r17 | CellReselectionPriority |

OPTIONAL, -- Need R

| | |
|---|---|
| nsag-CellReselectionSubPriority-r17 | CellReselectionSubPriority |

OPTIONAL, -- Need R

| | |
|---|---|
| sliceCellListNR-r17 | CHOICE { |
| sliceAllowedCellListNR-r17 | SliceCellListNR-r17, |
| sliceExcludedCellListNR-r17 | SliceCellListNR-r17 |

| | |
|---|---|
| } | OPTIONAL -- Need R |

}

| | |
|---|---|
| SliceCellListNR-r17 ::= | SEQUENCE (SIZE (1..maxCellSlice-r17)) OF PCI-Range |

```
  -- TAG-FREQPRIORITYLISTSLICING-STOP
  -- ASN1STOP
```

Detailed description of the fields is available in 3gpp specification TS 38.331 V17.1.0. As we can see, nsag-CellReselectionPriority and nsag-CellReselectionSubPriority are optional in slice information for both sliceInfo and sliceInfoDedicated.

When the UE performs slice based cell reselection, the priority used for cell reselection is a combination of both slice priority/NSAG priority received from NAS and frequency priority received from RRC. There are two ways by which sliceInformation (for e.g. FreqPriorityNRSlicing) could be received by the UE (One by broadcast signaling (SIB16) and other by dedicated signalling in RRC messages like RRC release). The SIB16 structure is given as below:

-- ASN1START
-- TAG-SIB16-START

| SIB16-r17 ::= | SEQUENCE { | |
|---|---|---|
| freqPriorityListNRSlicing-r17 | FreqPriorityListNRSlicing-r17 | OPTIONAL, -- |

Need R

| | | |
|---|---|---|
| lateNonCriticalExtension | OCTET STRING | OPTIONAL, |

```
  ...
}
-- TAG-SIB16-STOP
-- ASN1STOP
    RRC Release may include cellReselectionPriorities as below.
```

| | |
|---|---|
| CellReselectionPriorities ::= | SEQUENCE { |
| freqPriorityListEUTRA | FreqPriorityListEUTRA |

OPTIONAL, -- Need M

| | |
|---|---|
| freqPriorityListNR | FreqPriorityListNR |

OPTIONAL, -- Need M

| | |
|---|---|
| t320 | ENUMERATED {min5, min10, min20, min30, min60, min120, |

```
  min180, spare1} OPTIONAL, -- Need R
  ...,
  [[
```

| | |
|---|---|
| freqPriorityListNRSlicing-r17 | FreqPriorityListNRSlicing-r17 |

```
  OPTIONAL -- Need M
  ]]
}
```

| | |
|---|---|
| FreqPriorityListEUTRA ::= | SEQUENCE (SIZE (1..maxFreq)) OF |

FreqPriorityEUTRA

| | |
|---|---|
| FreqPriorityListNR ::= | SEQUENCE (SIZE (1..maxFreq)) OF FreqPriorityNR |
| FreqPriorityEUTRA ::= | SEQUENCE { |
| carrierFreq | ARFCN-ValueEUTRA, |
| cellReselectionPriority | CellReselectionPriority, |
| cellReselectionSubPriority | CellReselectionSubPriority |

OPTIONAL -- Need R
}

| | |
|---|---|
| FreqPriorityNR ::= | SEQUENCE { |
| carrierFreq | ARFCN-ValueNR, |
| cellReselectionPriority | CellReselectionPriority, |
| cellReselectionSubPriority | CellReselectionSubPriority |

OPTIONAL -- Need R
}

Slice Aware Cell Reselection Procedure: As per 3GPP Release 17.0.0 TS 38.304 specification, the UE derives slice specific cell reselection priorities when the UE performs slice-based cell reselection as below:

The UE derives re-selection priorities for slice-based cell re-selection by using:
a) NSAGs and their priorities provided by NAS,
b) sliceInfoList and or sliceInfoListDedicated per frequency with nsag-CellReselectionPriority per NSAG, if provided in system information and/or dedicated signalling, and
c) cellReselectionPriority per frequency provided in system information and/or dedicated signalling.

The UE considers an NR frequency to support a slice group if
a) the corresponding nsag-ID is indicated for the NR frequency and valid for current TA.

The UE considers a cell on an NR frequency to support the slice group if
a) the corresponding nsag-ID is indicated for the NR frequency and valid for current TA; and
b) the cell is either listed in the sliceAllowedCellListNR (if provided in the used slice specific cell reselection information) or the cell is not listed in the sliceExcludedCellListNR (if provided in the used slice specific cell reselection information); or
c) Neither sliceAllowedCellListNR nor sliceExcludedCellListNR is configured in the used slice specific cell reselection information.

The UE derives re-selection priorities for slice-based cell re-selection according to the following rules:
a) Frequencies that support at least one prioritized NSAG received from NAS have higher re-selection priority than frequencies that support none of the NSAG(s) received from NAS.
b) Frequencies that support at least one NSAG provided by NAS are prioritized in the order of the NAS-provided priority for the NSAG with highest priority supported on the frequency.
c) Among the frequencies (one or multiple) that support the highest prioritized NSAG(s) with the same NAS-provided priorities, the frequencies are prioritized in the order of their nsag-CellReselectionPriority given for these NSAG(s).
d) Frequencies that support a NSAG provided by NAS and that indicate nsag-CellReselectionPriority for the NSAG have higher re-selection priority than frequencies that support the prioritized NSAG without indicating nsag-CellReselectionPriority for the NSAG.
e) Frequencies that support none of the NSAG(s) provided by NAS are prioritized in the order of their cellReselectionPriority.

Further during the cell reselection, the slice specific cell reselection priority may be re-derived when the best cell doesn't support highest priority frequency.

For the UE performing slice-based cell reselection if the cell fulfils the above criteria for the cell reselection based on re-selection priority for the frequency and the slice group derived according to above rules, but the cell does not support the slice group based on above conditions, the UE re-derives a re-selection priority for the frequency by considering the slice group(s) supported by the cell (rather than those of the corresponding NR frequency) according to clause above rules. The reselection priority is used until the highest ranked cell changes on the frequency, or new slice or slice group priorities are received from NAS. The UE ensures the cell reselection criteria above are fulfilled based on the newly derived priorities.

In case, the UE receives RRCRelease with deprioritisationReq, the UE considers current frequency and stored frequencies due to the previously received RRCRelease with deprioritisationReq or all the frequencies of NR to be the lowest priority frequency (i.e. lower than any of the network configured values) while T325 is running irrespective of camped RAT. The UE deletes the stored deprioritisation request(s) when a PLMN selection or SNPN selection is performed on request by NAS.

It is desired to address the above mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a method for handling slice based cell reselection priorities. The method includes receiving, by a UE, a RRC message including a slice information for a NSAG at a frequency and without any priority information. Further, the method includes receiving, by the UE, a RRC message including a slice information for a NSAG including priority information for a NSAG at another frequency. Further, the method includes determining, by the UE, whether the RRC message includes the slice information with the priority information or the slice information without the priority information. Further, the method includes determining, by the UE, a lowest priority value for the frequency when the RRC message includes the slice information without the priority information, where the lowest priority value is lower than any of the priority information configured for the frequency. This lowest priority value is applied for the frequency during the slice based cell reselection priority calculation with respect to the corresponding NSAG. Further, the method includes performing, by the UE, cell reselection based on the lowest priority value for the frequency and the slice information.

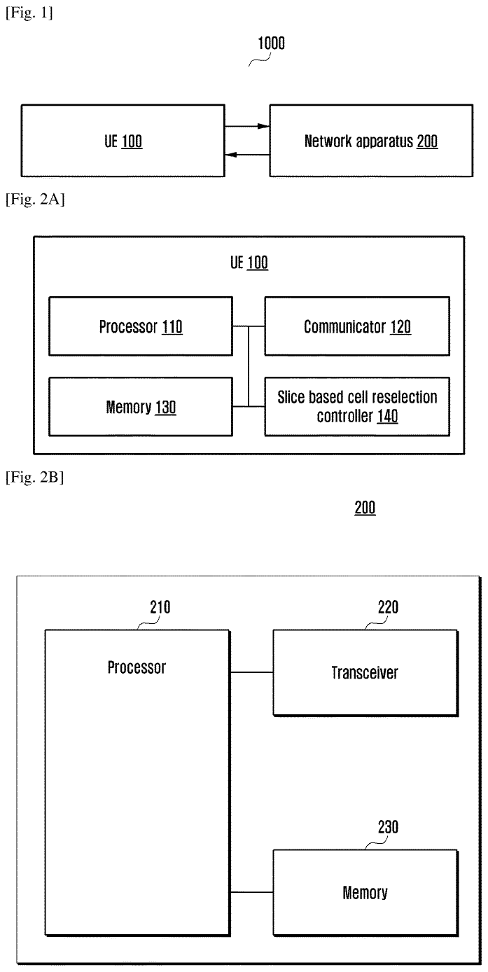

Referring now to the drawings, and more particularly to FIGS. 1 through 6, there are shown preferred embodiments.

FIG. 1 illustrates a wireless network (1000) for handling slice based cell reselection priorities, according to the embodiments as disclosed herein. The wireless network (1000) can be, for example, but not limited to a fourth generation (4G) network, a fifth generation (5G) network, an Open Radio Access Network (ORAN) or the like. In an embodiment, the wireless network (1000) includes a UE (100) and a network apparatus (200).

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

The UE (100) receives a RRC message, from the network apparatus (200), comprising a slice information for a NSAG at a frequency and without any priority information. The priority information includes at least one of a nsag-CellReselectionPriority, a nsag-CellReselectionSubPriority, CellReselectionPriority and CellReselectionSubPriority. The RRC message can be, for example, but not limited to a RRCRelease or the SIB. The SIB is one of a SIB2 and a SIB4.

Further, the UE (100) receives the RRC message comprising the slice information for the NSAG comprising priority information for the NSAG at another frequency. Further, the UE (100) determines whether the RRC message comprises the slice information with the priority information or the slice information without the priority information. Further, the UE (100) determines a lowest priority value for the frequency when the RRC message comprises the slice information without the priority information. The lowest priority value is lower than any of the priority information configured for the frequency. Further, the UE (100) performs cell reselection based on the lowest priority value for the frequency and the slice information.

Further, the UE (100) ignores the priority information received in a SIB. Further, the UE (100) performs the slice based cell reselection using only the NSAG-Frequency pairs without priority information received in a RRC Release when the RRCRelease comprises the slice information including NSAG-Frequency pairs without including the priority information for all the NSAG-Frequency pairs. In other words, the UE (100) derives the cell reselection priorities using the NSAG-Frequency pair, applying the rules for deriving the slice based cell reselection priorities and performs the cell reselection. This is unlike the traditional systems, where the UE (100) doesn't perform cell reselection if the cell reselection priorities are not provided.

Further, the UE (100) receives the slice information for a first frequency (F1) and a second frequency (F2), where the slice information for the F1 doesn't include the priority information and the slice information for the F2 includes the priority information set as zero. Further, the UE (100) determines the F2 is higher priority than the F1 when the F1 doesn't include the priority information and the F2 includes the priority information set as zero.

In an example, when the UE (100) has received freqPriorityListDedicatedSlicing (i.e. list of dedicated slice information) with SliceInfoListDedicated (i.e., dedicated slice information) where all the SliceInfoDedicated contains only nsag-IdentityInfo (i.e. identity of NSAG) and doesn't include any cell reselection priority (optional information nsag-CellReselectionPriority and nsag-CellReselectionSubPriority), the UE (100) ignores the cell reselection priority and cell reselection sub-priority received in inter-frequency carrier information (i.e., InterFreqCarrierFreqInfo) and cellReselectionServingFreqInfo within the system information (for e.g. NR SIB4 and NR SIB2).

In an embodiment, the UE (100) has received slice information lists through dedicated signalling (in a NR RRCRelease) where the slice information (in a NR SliceInfoDedicated) in all the received slice information lists (in NR SliceInfoListDedicated) for all the frequencies provided in RRCRelease, doesn't include any priority (i.e. doesn't include nsag-CellReselectionPriority and nsag-CellReselectionSubPriority) and has not received any NR or E-UTRA frequencies associated to non-slice specific priorities (i.e., has not received freqPriorityListNR or freqPriorityListEUTRA including cellReselectionPriority or cellReselectionSubPriority in NR) in RRCRelease. Further, the UE (100) ignores any of the received non slice specific cell reselection priorities and subpriorities in the system information. That is, in this case, the UE (100) ignores cellReselectionPriority or cellReselectionSubPriority in InterFreqCarrierFreqInfo received in NR SIB4 and cellReselectionPriority or cellReselectionSubPriority in cellReselectionServingFreqInfo in NR SIB2 and performs cell reselection prioritisation without using the above ignored information. The UE (100) may also ignore any NSAG specific cell reselection priorities received in the system information (i.e. ignore nsag-CellReselectionPriority and nsag-CellReselectionSubPriority in SIB16). This is unlike the traditional systems where the decision to ignore the cell reselection priority in the system information depends on the presence of at least one field with cell reselection priority alone. Here, the UE (100) ignores the cell reselection priority in the system information based on the presence of NSAG, and the frequency pair even when there is no cell reselection priority.

When the RRCRelease includes the slice information without including any priority (i.e. without including nsag-CellReselectionPriority and nsag-CellReselectionSubPriority), the UE (100) ignores cellReselectionPriority or cellReselectionSubPriority received in the SIB2 and the SIB4.

When the RRCRelease includes the slice information without including any priority (i.e. without including nsag-CellReselectionPriority and nsag-CellReselectionSubPriority), the UE (100) ignores the nsag-CellReselectionPriority and nsag-CellReselectionSubPriority in the SIB16.

When the UE (100) receives the RRCRelease with cellReselectionPriorities, the UE (100) ignores all the priorities provided in system information. As mentioned in the background, the cellReselectionPriorities can include FreqPriorityListDedicatedSlicing (list of dedicated slice information's, each slice information including the NSAG-Frequency information and optionally the corresponding priorities), freqPriorityListNR or freqPriorityListEUTRA. When the UE (100) receives any of the parameters in the RRCRelease, the UE (100) ignores all the priorities provided in the system information, such as for NR, all the priorities provided in freqPriorityListNRSlicing in the SIB16 or IntraFreqCellReselectionInfo in the SIB2 or InterFreqCarrierFreqList in the SIB4. For example, if the FreqPriorityListDedicatedSlicing is configured, the UE (100) doesn't consider any of the priorities from the list freqPriorityListNRSlicing in the system information. Hence if there are some NSAG-frequency pairs present in the FreqPriorityListDedicatedSlicing and the different set of NSAG-frequency pairs are present in FreqPriorityListNRSlicing, the UE (100) ignores the NSAG-frequency pairs present in FreqPriorityListNRSlicing which are not present in FreqPriorityListDedicatedSlicing. This means that with this embodiment, the UE (100) considers only the NSAG-Frequency pairs in FreqPriorityListDedicatedSlicing for deriving priorities for the slice based cell reselection. In another embodiment, when the UE (100) receives the RRCRelease including cellReselectionPriority or cellReselectionSubPriority, the UE (100) ignores any slice Information received in SIB16.

Prioritisation between a frequency without nsag-CellReselectionPriority in the slice information and a frequency with nsag-CellReselectionPriority set as zero in the slice information:

In an embodiment, when the UE (100) receives slice information (either sliceInfo in SIB16 or sliceInfoDedicated in the RRCRelease) from the network apparatus (200) for two frequencies F1 and F2 for the NSAG, the NSAG1 and the sliceInfo for the F1 doesn't contain NSAG cell reselection priority (i.e., doesn't contain nsag-CellReselectionPriority and nsag-CellReselectionSubPriority) for the NSAG1 while sliceInfo for F2 contain NSAG cell reselection priority as zero, (nsag-CellReselectionPriority is set as zero and nsag-CellReselectionSubPriority is not present), the UE (100) considers F1 and F2 are equal priorities for the slice based cell reselection.

In an alternate embodiment, when the UE (100) receives slice information (either sliceInfo from the SIB or sliceInfoDedicated in RRCRelease) from the network apparatus (200) for two frequencies F1 and F2 for the NSAG, the NSAG1 and the sliceInfo for the F1 doesn't contain NSAG cell reselection priority (i.e. doesn't contain nsag-CellReselectionPriority and nsag-CellReselectionSubPriority) for NSAG1 while the sliceInfo for F2 contains the NSAG cell reselection priority as zero, (nsag-CellReselectionPriority is set as zero and nsag-CellReselectionSubPriority is not present), the UE (100) considers F2 as higher priority than the F1 for slice based cell reselection.

As an example, there are two frequencies i.e. F1: supports NSAG1 but network apparatus (200) is not indicating any nsag-CellReselectionPriority in the sliceInfo for NSAG1. The F2 supports NSAG1 but network apparatus (200) is indicating nsag-CellReselectionPriority to 0 for NSAG1. In this case, the F2 and F1 have equal slice based cell reselection priority whereas the NSAG1 is the highest prioritised NSAG based on NAS based priorities.

In an alternate embodiment, when the UE (100) receives slice information (either sliceInfo from the SIB or sliceInfoDedicated in the RRCRelease) from the network apparatus (200) for two frequencies F1 and F2 for the NSAG, the NSAG1 and the sliceInfo for the F1 doesn't contain NSAG cell reselection priority (i.e. doesn't contain nsag-CellReselectionPriority and nsag-CellReselectionSubPriority) for the NSAG1 while sliceInfo for the F2 contain NSAG cell reselection priority as zero, (nsag-CellReselectionPriority is set as zero and nsag-CellReselectionSubPriority is not present), the UE (100) considers the F2 as higher priority than F1 for slice based cell reselection.

As an example, there are two frequencies i.e. F1: supports NSAG1 but the network apparatus (200) is not indicating any nsag-CellReselectionPriority in the sliceInfo for NSAG1 and the F2 supports NSAG1 but the network apparatus (200) is indicating nsag-CellReselectionPriority to 0 for NSAG1. In this case, the F2 has higher slice based cell reselection priority than F1 whereas NSAG1 is the highest prioritised NSAG based on NAS based priorities. The F1, without including nsag-CellReselectionPriority and nsag-CellReselectionSubPriority is considered as the lowest priority among the F1 and the F2. Such an operation provides the network apparatus (200) more flexibility for signaling. Since the lowest configurable value for slice-specific cell reselection priority is ‘0’, the network apparatus (200) can use an additional procedures for configuration and thereby provide a priority which is even lower than ‘O’, with less signalling overhead. This increases the options for prioritizing the frequencies without increasing the signalling overhead. Normally, if the network apparatus (200) wants to signal nine levels of priority, the overhead is much more than that of signalling eight levels of priority as another bit needs to be reserved and such a reservation is not feasible in many deployments. Thus using absence of priority as an additional option, networks can configure more priority levels in an optimized and efficient way.

In an alternate embodiment, when the UE (100) receives slice information (either sliceInfo from the SIB or sliceInfoDedicated in RRCRelease) from the network apparatus (200) for two frequencies F1 and F2 for the NSAG, the NSAG1 and the sliceInfo for the F1 doesn't contain NSAG cell reselection priority (i.e. doesn't contain nsag-CellReselectionPriority and nsag-CellReselectionSubPriority) for NSAG1 while sliceInfo for F2 contain NSAG cell reselection priority as zero, (nsag-CellReselectionPriority is set as zero and nsag-CellReselectionSubPriority is not present), we propose that the UE (100) consider F1 as higher priority than F2 for slice based cell reselection.

FIG. 2A shows various hardware components of the UE (100), according to the embodiments as disclosed herein. In an embodiment, the UE (100) includes a processor (110), a communicator (120), a memory (130) and a slice based cell reselection controller (140). The processor (110) is coupled with the communicator (120), the memory (130) and the slice based cell reselection controller (140).

The slice based cell reselection controller (140) receives the RRC message comprising the slice information for the NSAG at the frequency and without any priority information. The priority information includes the nsag-CellReselectionPriority, the nsag-CellReselectionSubPriority, the CellReselectionPriority and the CellReselectionSubPriority. The RRC message can be, for example, but not limited to the RRCRelease or the SIB. The SIB is one of a SIB2 and a SIB4.

Further, the slice based cell reselection controller (140) receives the RRC message comprising the slice information for the NSAG comprising priority information for the NSAG at another frequency. Further, the slice based cell reselection controller (140) determines whether the RRC message comprises the slice information with the priority information or the slice information without the priority information. Further, the slice based cell reselection controller (140) determines the lowest priority value for the frequency when the RRC message includes the slice information without the priority information. The lowest priority value is lower than any of the priority information configured for the frequency. Further, the slice based cell reselection controller (140) performs cell reselection based on the lowest priority value for the frequency and the slice information.

Further, the slice based cell reselection controller (140) configures to ignore the priority information received in at least one system information block (SIB). Further, the slice based cell reselection controller (140) performs the slice based cell reselection using only the NSAG-Frequency pairs without priority information received in a RRC Release when the RRCRelease comprises the slice information including NSAG-Frequency pairs without including the priority information for all the NSAG-Frequency pairs and the RRC Release does not comprises the NR frequencies or the E-UTRA frequencies associated to non-slice specific priorities.

Further, the slice based cell reselection controller (140) performs the slice based cell reselection by considering only the NSAG-frequency pairs indicated in the FreqPriority ListDedicatedSlicing.

Further, the slice based cell reselection controller (140) receives the slice information for a first frequency (F1) and a second frequency (F2), where the slice information for the F1 doesn't include the priority information and the slice information for the F2 includes the priority information set as zero. Further, the slice based cell reselection controller (140) determines the F2 is higher priority than the F1 when the F1 doesn't include the priority information and the F2 includes the priority information set as zero.

The slice based cell reselection controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The processor (110) is a general-purpose processor, such as a Central Processing Unit (CPU), an application processor, or the like, a graphics-only processing unit such as a Graphics Processing Unit (GPU), a Visual Processing Unit (VPU) and the like. The processor (110) includes multiple cores to execute the instructions. The communicator (120) is configured for communicating internally between internal hardware components and with external devices via one or more networks. The communicator (120) is configured for communicating internally between hardware components in the UE (100). The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2A shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 2B illustrates a network apparatus according to embodiments of the present disclosure.

Referring to the FIG. 2B, the network apparatus 200 may include a processor 210, a transceiver 220 and a memory 230. However, all of the illustrated components are not essential. The network apparatus 200 may be implemented by more or less components than those illustrated in FIG. 2B. In addition, the processor 210 and the transceiver 220 and the memory 230 may be implemented as a single chip according to another embodiment.

The network apparatus 200 may correspond to the gNB described above. For example, the network apparatus 200 may correspond to network apparatus 200 illustrated in FIG. 1.

The aforementioned components will now be described in detail.

The processor 210 may include one or more processors or other processing devices that control the proposed function, process, and/or method. Operation of the network apparatus 200 may be implemented by the processor 210.

The transceiver 220 may include a RF transmitter for up-converting and amplifying a transmitted signal, and a RF receiver for down-converting a frequency of a received signal. However, according to another embodiment, the transceiver 220 may be implemented by more or less components than those illustrated in components.

The transceiver 220 may be connected to the processor 210 and transmit and/or receive a signal. The signal may include control information and data. In addition, the transceiver 220 may receive the signal through a wireless channel and output the signal to the processor 210. The transceiver 220 may transmit a signal output from the processor 210 through the wireless channel.

The memory 230 may store the control information or the data included in a signal obtained by the network apparatus 200. The memory 230 may be connected to the processor 210 and store at least one instruction or a protocol or a parameter for the proposed function, process, and/or method. The memory 230 may include read-only memory (ROM) and/or random access memory (RAM) and/or hard disk and/or CDROM and/or DVD and/or other storage devices.

Although this disclosure has been described with an exemplary embodiment, various changes and modifications may be suggested to one skilled in the art. It is intended that this disclosure encompass such changes and modifications as fall within the scope of the appended claims.

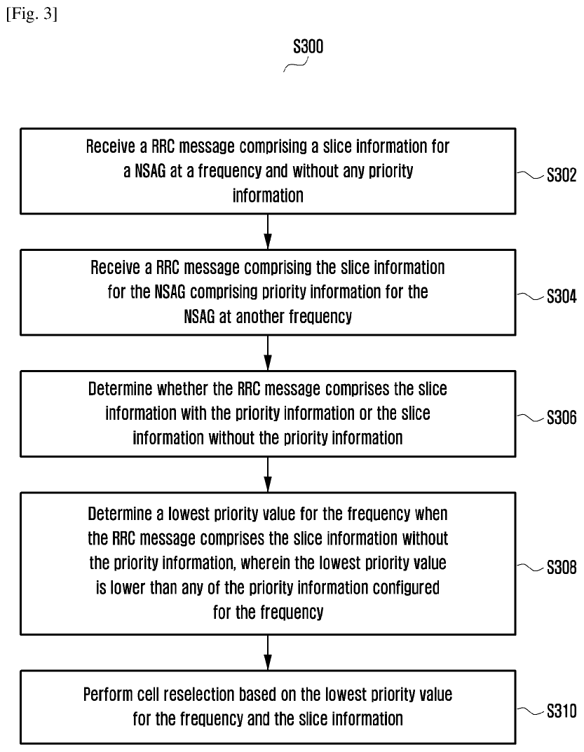

FIG. 3 is a flow chart (S300) illustrating a method for handling slice based cell reselection priorities, according to the embodiments as disclosed herein. The operations (S302-S310) are handled by the slice based cell reselection controller (140).

At step S302, the method includes receiving the RRC message including the slice information for the NSAG at the frequency and without any priority information. At step S304, the method includes receiving the RRC message including the slice information for the NSAG including priority information for the NSAG at another frequency. At step S306, the method includes determining whether the RRC message includes the slice information with the priority information or the slice information without the priority information. At step S308, the method includes determining the lowest priority value for the frequency when the RRC message includes the slice information without the priority information. The lowest priority value is lower than any of the priority information configured for the frequency. At step S310, the method includes performing cell reselection based on the lowest priority value for the frequency and the slice information.

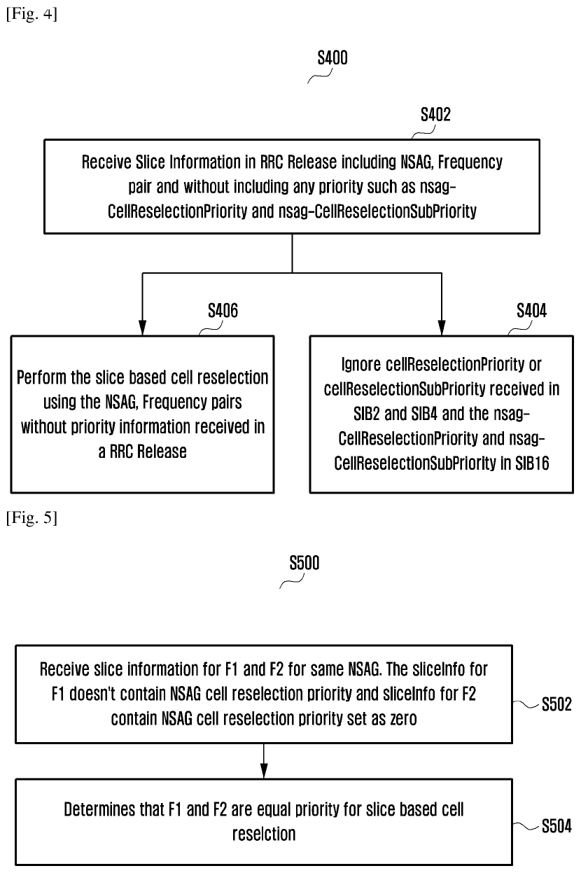

FIG. 4 is a flow chart (S400) illustrating a method for handling of the RRC release with the slice information without any priority, according to the embodiments as disclosed herein. The operations (S402-S406) are handled by the slice based cell reselection controller (140).

At step 402, the method includes receiving the slice information in the RRC Release without including any priority such as nsag-CellReselectionPriority and nsag-CellReselectionSubPriority. At step 404, the method includes ignoring the cellReselectionPriority or cellReselectionSubPriority received in the SIB2 and the SIB4 and ignoring the nsag-CellReselectionPriority and nsag-CellReselectionSubPriority in the SIB16. At step 406, the method includes performing the slice based cell reselection using the NSAG, Frequency pairs without priority information received in the RRC Release.

FIG. 5 is a flow chart (S500) illustrating a method for handling slice based prioritisation between the NSAG cell reselection priority absent and NSAG cell reselection priority is zero, according to the embodiments as disclosed herein. The operations (S502-S504) are handled by the slice based cell reselection controller (140).

At step 502, the method includes receiving the slice information for the F1 and the F2 for same NSAG. The sliceInfo for F1 doesn't contain NSAG cell reselection priority and the sliceInfo for F2 contains NSAG cell reselection priority set as zero. At step 504, the method includes determines that F1 and F2 are equal priority for the slice based cell reselection.

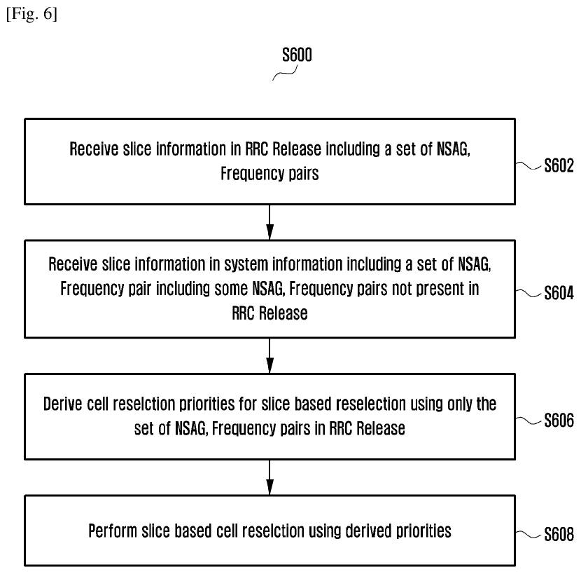

FIG. 6 is a flow chart (S600) illustrating a method for handling slice based cell reselection using derived priorities, according to the embodiments as disclosed herein. The operations (S602-S608) are handled by the slice based cell reselection controller (140).

At step S602, the method includes receiving the slice information in the RRC release including the set of NSAG, Frequency pairs. At step S604, the method includes receiving the slice information in the system information including the set of NSAG, the frequency pair including some NSAG, the frequency pairs not present in the RRC release. At step S606, the method includes deriving the cell reselection priorities for the slice based reselection using only the set of NSAG and the frequency pairs in the RRC Release. At step S608, the method includes performing the slice based cell reselection using the derived priorities.

The various actions, acts, blocks, steps, or the like in the flow charts (S300-S600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless communication system for handling slice based cell reselection priorities, the method comprising:
receiving, from a network apparatus, a radio resource control (RRC) release message including first information on first frequency pairs associated with a network slice AS group (NSAG);
identifying whether system information block (SIB) including second information on second frequency pairs associated with the NSAG is obtained or not;
in case that the SIB including the second information is obtained, performing a slice based cell reselection based on the first information; and
determining that a priority of a first frequency is higher than a priority of a second frequency, in case that slice information for the first frequency does not include priority information and slice information for the second frequency includes priority information which is set to zero.

2. The method of claim 1,
wherein the SIB includes SIB16, and
wherein the slice based cell reselection is performed further based on the first information and cell lists included in the SIB16.

3. The method of claim 2, wherein the first slice information is included in a FreqPriorityListDedicatedSlicing of the RRC release message.

4. The method of claim 3, further comprising:
in case that the FreqPriorityListDedicatedSlicing is configured, only considering the first frequency pairs indicated in the FreqPriorityListDedicatedSlicing for the slice based cell reselection.

5. The method of claim 1, further comprising:
receiving, from the network apparatus, the slice information for the first frequency and the slice information for the second frequency.

6. The method of claim 3, wherein the FreqPriorityListDedicatedSlicing comprises at least one of an nsag-CellReselectionPriority and an nsag-CellReselectionSubPriority.

7. A method performed by a network apparatus in a wireless communication system for handling slice based cell reselection priorities, the method comprising:
generating a radio resource control (RRC) release message including first information on first frequency pairs associated with a network slice AS group (NSAG) for configuring whether a slice based cell reselection based on the first information is to be performed by a user equipment (UE) depending on whether system information block (SIB) including second information on second frequency pairs associated with the NSAG is obtained;
generating slice information for a first frequency and slice information for a second frequency for configuring to be determined by the UE whether a priority of the first frequency is higher than a priority of the second frequency in case that the slice information for the first frequency does not include priority information and the slice information for the second frequency includes priority information which is set to zero; and
transmitting, to the UE, the RRC release message.

8. The method of claim 7,
wherein the SIB includes SIB16, and
wherein the slice based cell reselection is performed further based on the first information and cell lists included in the SIB16.

9. The method of claim 8, wherein the first information is included in a FreqPriorityListDedicatedSlicing of the RRC release message.

10. The method of claim 9,
wherein in case that the FreqPriorityListDedicatedSlicing is configured, the first frequency pairs indicated in the FreqPriorityListDedicatedSlicing for the slice based cell reselection is only considered.

11. The method of claim 7, further comprising:
transmitting, to the UE, the slice information for the first frequency and the slice information for the second frequency.

12. The method of claim 9, wherein the FreqPriorityListDedicatedSlicing comprises at least one of an nsag-CellReselectionPriority and an nsag-CellReselectionSubPriority.

13. A user equipment (UE) in a wireless communication system for handling slice based cell reselection priorities, the UE comprising:
a transceiver configured to transmit and receive a signal; and
a processor coupled to the transceiver, wherein the processor is configured to:
receive, from a network apparatus, a radio resource control (RRC) release message including first information on first frequency pairs associated with a network slice AS group (NSAG),
identify whether system information block (SIB) including second information on second frequency pairs associated with the NSAG is obtained or not,
in case that the SIB including the second information is obtained, perform a slice based cell reselection based on the first information, and
determine that a priority of a first frequency is higher than a priority of a second frequency, in case that slice information for the first frequency does not include priority information and slice information for the second frequency includes priority information which is set to zero.

14. The UE of claim 13,
wherein the SIB includes SIB16, and
wherein the slice based cell reselection is performed further based on the first information and cell lists included in the SIB16.

15. A network apparatus in a wireless communication system for handling slice based cell reselection priorities, the network apparatus comprising:
a transceiver configured to transmit and receive a signal; and
a processor coupled to the transceiver, wherein the processor is configured to:
generate a radio resource control (RRC) release message including first information on first frequency pairs associated with a network slice AS group (NSAG) for configuring whether a slice based cell reselection based on the first information is to be performed by a user equipment (UE) depending on whether system information block (SIB) including second information on second frequency pairs associated with the NSAG is obtained,
generate slice information for a first frequency and slice information for a second frequency for configuring to be determined by the UE whether a priority of the first frequency is higher than a priority of the second frequency in case that the slice information for the first frequency does not include priority information and the slice information for the second frequency includes priority information which is set to zero,
transmit, to the UE, the RRC release message.
